(19) United States
(12) Patent Application Publication
(10) Pub. No.: US 2013/0318381 A1
(43) Pub. Date: Nov. 28, 2013

(54) ELECTRONIC APPARATUS AND START METHOD FOR ELECTRONIC APPARATUS

(71) Applicant: KABUSHIKI KAISHA TOSHIBA, Tokyo (JP)

(72) Inventor: Hiroshi Sugano, Tachikawa-Shi (JP)

(73) Assignee: KABUSHIKI KAISHA TOSHIBA, Tokyo (JP)

(21) Appl. No.: 13/781,593

(22) Filed: Feb. 28, 2013

(30) Foreign Application Priority Data
May 25, 2012 (JP) 2012-119749

(51) Int. Cl. G06F 9/48; G06F 1/32

(52) U.S. Cl. CPC G06F 9/4893; G06F 1/32
USPC 713/323

(57) ABSTRACT

According to one embodiment, an apparatus includes a manager configured to perform power management for the apparatus corresponding to a normal mode and a power saving mode configured to consume less electrical power than in the normal mode, a processor configured to execute one of a first program and at least one other program, a request module configured to request the manager to perform the power management corresponding to the normal mode when a touchscreen display detects simultaneous touches at positions, and a controller configured to start the first program and to cause the processor to execute the first program when a number of detected touched positions corresponds to the first program after the apparatus recovers to the normal mode.

### CROSS-REFERENCE TO RELATED APPLICATIONS

This application is based upon and claims the benefit of priority from Japanese Patent Application No. 2012-119749, filed May 25, 2012, the entire contents of which are incorporated herein by reference.

### FIELD

Embodiments described herein relate generally to an electronic apparatus comprising a touchscreen display, and a start method for the same.

### BACKGROUND

In recent years, various types of electronic apparatuses, such as a tablet, PDA, and a smart phone, are developed. Most of these electronic apparatuses each comprise a touchscreen display to facilitate input operations by users.

There is a demand for starting such an electronic apparatus by using a touchscreen display.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing exterior of an electronic apparatus according to an embodiment.

FIG. 2 is an exemplary block diagram showing a system configuration of the electronic apparatus according to the embodiment.

FIG. 3 is an exemplary block diagram showing a system configuration to achieve easy start.

FIG. 4 is an exemplary diagram showing data stored in an allocation table.

FIG. 5 is an exemplary flowchart showing a processing procedure of the easy start.

FIG. 6 is an exemplary flowchart showing a processing procedure at the time of power on.

### DETAILED DESCRIPTION

Various embodiments will be described hereinafter with reference to the accompanying drawings.

In general, according to one embodiment, an electronic apparatus comprises a normal mode and a power saving mode configured to consume less electrical power than in the normal mode. The apparatus comprises an electrical power manager, a touchscreen display, a processor, a request module, and a controller. The electrical power manager is configured to perform power management for the apparatus corresponding to each of the normal mode and the power saving mode. The processor is configured to execute one of a first program and at least one other program. The request module is configured to request the electrical power manager to perform the power management corresponding to the normal mode when the touchscreen display detects simultaneous touches at positions while the apparatus is in the power saving mode. The controller is configured to start the first program and to cause the processor to execute the first program when a number of detected touched positions corresponds to the first program after the apparatus recovers to the normal mode.

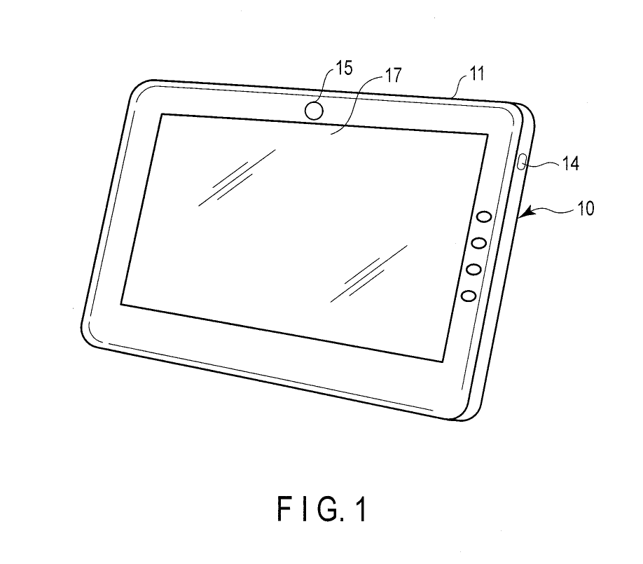

Firstly, a configuration of an electronic apparatus according to the present embodiment will be described with reference to FIG. 1. The electronic apparatus can be manufactured as a mobile terminal, for example, a tablet computer, a laptop or notebook computer, or a PDA. Hereinafter, descriptions will be made supposing that an electronic-program-guide display apparatus is manufactured as a tablet personal computer 10 (hereinafter referred to as a computer 10).

FIG. 1 is a view showing exterior of the computer 10. The computer 10 comprises a computer body 11, and a touchscreen display 17. The computer body 1 comprises a thin box-type housing. On a surface of the computer body 11, a power button 14 is provided to power on/off the computer 10, and a camera 15 is provided in a front surface of the computer body 11. The touchscreen display 17 is provided on the surface of the computer body 1. The touchscreen display 17 comprises a flat panel display (for example, a liquid crystal display [LCD]) and a touchpanel. The touchpanel is provided so as to cover a screen of the LCD. The touchpanel is configured to detect positions on the touchscreen display 17 touched by a user's finger or pen.

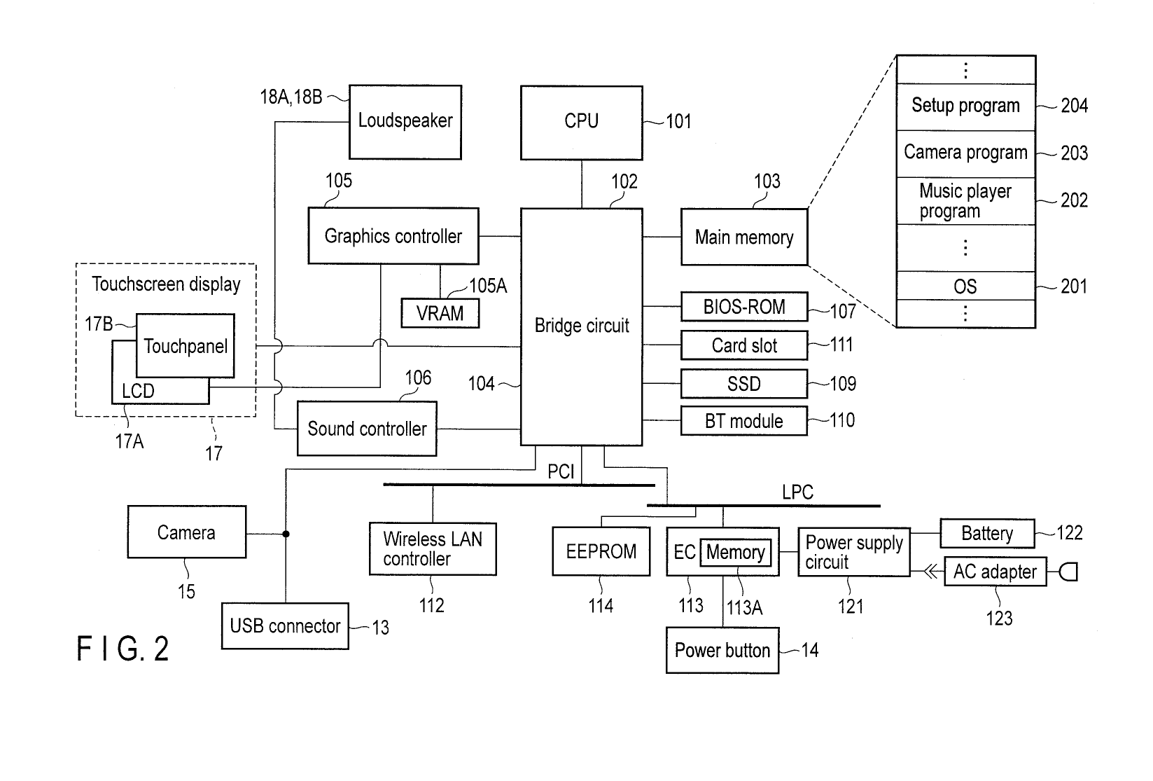

FIG. 2 is a block diagram showing an example system configuration of the computer 10.

The computer 10 comprises a central processing unit (CPU) 101, a bridge circuit 102, a main memory 103, a graphics controller (graphics processing unit [GPU]) 105, a sound controller 106, a BIOS-ROM 107, a solid-state drive (SSD) 109, a Bluetooth ([BT] registered trademark) module 110, a card slot 111, a wireless LAN controller 112, an embedded controller (EC) 113, an EEPROM 114, a USB connector 13, a touchscreen display 17, a video memory (VRAM) 105A, a power supply circuit 121, the power button 14, and a camera 15.

The CPU 101 is a processor which controls operations of individual sections in the computer 10. The CPU 101 executes an operating system (OS) 201 and various application programs which are loaded onto the main memory 103 from the SSD 109. A music player program 202, a camera program 203, and a setup program 204 are included in the application programs. The computer 10 supports multitasking. The CPU 101 principally executes one of the application programs.

The music player program 202 is an application program for playing back audio files. The camera program 203 functions to compress an image data file which is imaged by the camera 15 and/or to store the compressed file into a specific folder. The setup program 204 is a program for creating an allocation table which will be described later.

The CPU 101 also executes a basic input/output system (BIOS) stored in the BIOS-ROM 107. The BIOS is a program for hardware control.

The bridge circuit 102 is a bridge device which connects a local bus of the CPU101 with devices on a Peripheral Component Interconnect (PCI) bus and on a Low Pin Count (LPC) bus. The bridge circuit 102 further includes a serial advanced technology attachment (ATA) controller for controlling the SSD 109. Further, the bridge circuit 102 also functions to perform communication with the sound controller 106. Alternatively, the bridge circuit 102 may function to perform communication with the GPU 105 through a serial bus conformant to the PCI-EXPRESS standard.

The GPU 105 is a display controller which controls a LCD 17A used as a display monitor of the computer 10. A video signal (also referred to as a display signal) generated by the GPU 105 is fed to the LCD 17A.

The sound controller 106 is a sound source device, and outputs the audio data as a target to play back, to loudspeakers 18A and 18B. The wireless LAN controller 112 is a wireless communication device which performs wireless communication conformant to the IEEE 802.11 standard, for example.

The EC 113 is an embedded controller for electrical power management. The EC 113 functions to power on/off the computer 10 in accordance with operations of the power button 14 by the user. The power supply circuit 121 generates operating power to be supplied to individual components by using electrical power supplied from a battery 122 in the computer 10 or electrical power supplied from an external power supply, such as an AC/DC adaptor 123. Further, the power supply circuit 121 charges the battery 122 by using the electrical power supplied from the external power supply.

In addition to the LCD 17A, a touchpanel 17B is built in the touchscreen display 17. The touchpanel 17B layered on the LCD 17A comprises a sensor and a micro controller unit (MCU). If a touch operation is made on the touchpanel 17B, a position touched is detected by a sensor, and input information including the touched position on the touchpanel 17B is output by a touch controller.

The computer 10 enters into a sleep mode in which power consumption is less than in a normal mode when the power button 14 is manipulated while the computer 10 is active, or when the computer 10 is left unoperated continuously for a constant period.

The EC 113 performs electrical power management on the computer 10 in accordance with the normal mode and the sleep mode (power-saving mode). Even when the EC 113 is in the sleep mode, the EC 113 supplies drive electrical power to the touchpanel 17B.

Setting may be arranged so as to require input of a pass code when recovering from the sleep mode. In this device, even without inputting a pass code, a corresponding application program can be started by touching the touchscreen display 17 with a plurality of fingers.

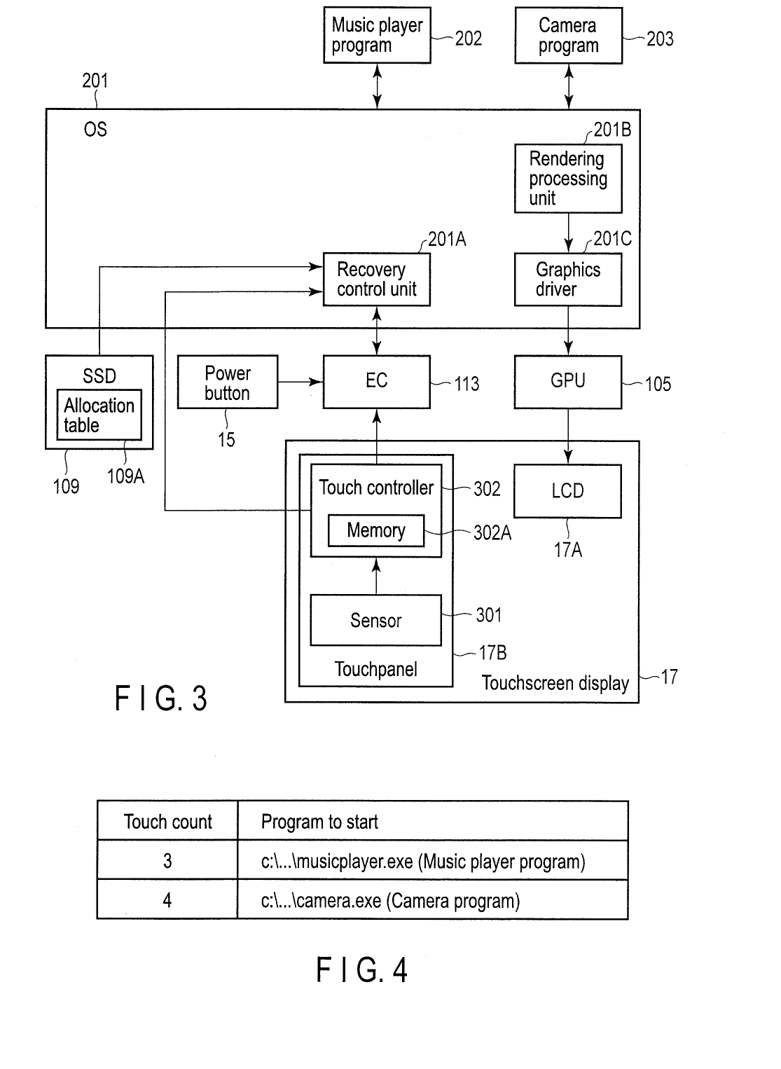

FIG. 3 is a block diagram showing a system configuration to achieve easy start.

The operating system (OS) 201 comprises a recovery control module 201A, a rendering processing module 201B, and a graphics driver 201C. The touchpanel 17B comprises a sensor 301 and a touch controller 302. The touch controller 302 comprises a memory 302A. An allocation table 109A is stored in the SSD 109.

FIG. 4 shows data stored in the allocation table 109A. As shown in FIG. 4, full paths of programs to start are associated, as information indicating the start programs, with numbers of touched positions. For example, as shown in FIG. 4, the full path (c:¥ . . . ¥musicplayer.exe) of a music player program is associated with the number of touched positions “3”. The full path (c:¥ . . . ¥camera.exe) of a camera program is associated with the number of touched positions “4”.

The allocation table 109A is generated by the setup program 204. The user selects a program to start corresponding to the number of touched positions by using the setup program 204. The setup program 204 prohibits programs (for example, a mailer and a contact address program) having security risks from being selected.

When the sensor 301 detects a plurality of positions touched on the touchpanel 17B, the sensor 301 then notifies the touch controller 302 of that the panel has been touched at the plurality of positions. The touch controller 302 stores, into the memory 302A, touch-position count information indicating the number of touched positions in accordance with the notification. The touch controller 302 requests the EC 113 to set the computer 10 into the normal mode. If there is an inquiry about the number of touched positions from the recovery control module 201A after being set into the normal mode, the touch controller 302 replies to the recovery control module 201A, with touch-position count information stored in the memory 302A.

The EC 113 performs a processing for recovery of the computer 10 back to the normal mode. If an inquiry about a factor causing the recovery is given from the recovery control module 201A after being set back to the normal mode, the EC 113 replies to the recovery control module 201A, with the factor causing the recovery to the normal mode. In case of recovery caused by an operation of the power button 14, the EC 113 replies that the recovery is caused by the operation of the power button 14. Otherwise, in case of recovery caused by a request from the touch controller 302, the EC 113 replies that the recovery is caused by a request from the touch controller 302.

Upon recovery of the normal mode, the recovery control module 201A inquires of the EC 113 about a factor causing the recovery. If the reply from EC113 indicates recovery caused by a request from the touch controller 302, the recovery control module 201A inquires of the touch controller 302 about the number of touched positions. If touch-position count information is notified from the touch controller 302, the recovery control module 201A determines whether touch-position count information identical to the touch-position count information notified of is recorded in the allocation table 109A or not. If recorded, the recovery control module 201A obtains information (full path) which indicates the program currently allocated to the touch-position count information from the allocation table 109A. The recovery control module 201A starts a program based on the obtained full path of the program. After the start, the recovery control module 201A prohibits starting of any other program and switching of the program which is principally executed by the CPU 101, to any other program. By prohibiting starting of any other programs, the other programs are prevented from being used. If recovery caused by an operation of the power button 14 is notified in response to the inquiry about any factor causing the recovery, the recovery control module 201A displays an input screen for a pass code on the LCD17A.

The rendering processing module 201B performs a processing to display, on the LCD 17A, an image based on display data generated by the program started last. The rendering processing module 201B generates image data based on the display data, and transmits the generated image data to the GPU 105 by the graphics driver 201C, to display the image on the LCD 17A. Although the computer 10 supports multitasking, an image based on display data generated by one program is principally displayed on the LCD17A.

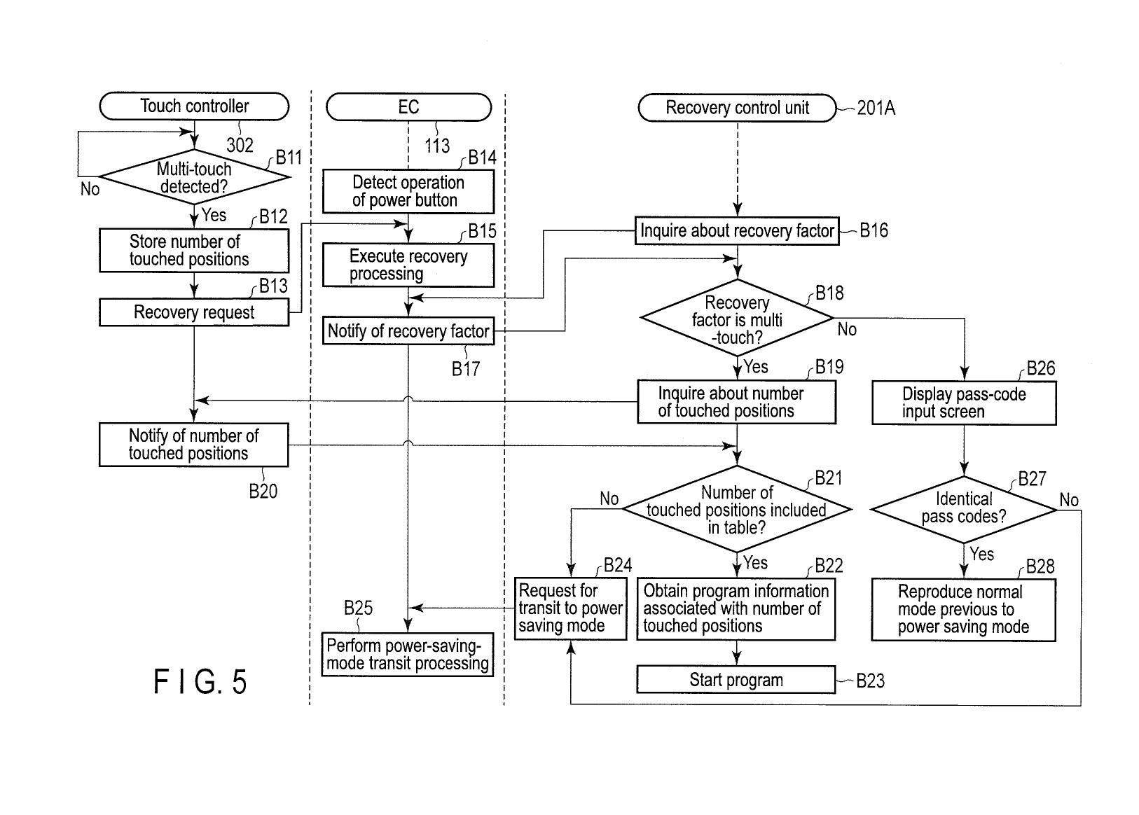

Next, FIG. 5 is a flowchart showing a processing procedure of easy start.

In the power-saving mode, the touch controller 302 determines whether a multi-touch has been made by touching a plurality of positions on the touchscreen display 17, based on a signal output from the sensor 301 (Block B11). If a multi-touch is determined to have been made (Yes in Block B11), the touch controller 302 stores, into the memory 302A, a multi-touch count, i.e., the number of touched positions (Block B12). The touch controller 302 requests recovery back to the normal mode from the EC 113 (Block B13). At the time of this request, the touch controller 302 notifies the EC 113 of a recovery request caused by a multi-touch. The EC 113 performs a processing for recovering the normal mode of the computer 10 in response to the request from the touch controller 302 (Block B15). When the EC 113 detects an operation of the power button 14 (Block B14), the EC 113 also performs the processing for recovering the normal mode of the computer 10 (Block B15).

When the operating system 201 is executed by the CPU101, the recovery control module 201A inquires of the EC 113 about a factor causing recovery (Block B16). The EC 113 notifies of a recovery factor in response to the inquiry (Block B17). If a multi-touch is the factor (Block B13), the EC 113 notifies the recovery control module 201A of that multi-touch is the factor. Otherwise, if an operation of the power button 14 is the factor (Block B14), the EC 113 notifies the recovery control module 201A of that an operation of the power button 14 is the factor.

The recovery control module 201A determines whether the recovery was caused by a multi-touch or not, based on the notified recovery factor (Block B18). If the recovery is determined to have been caused by a multi-touch (Yes in Block B18), the recovery control module 201A inquires of the touch controller 302 about the number of touched positions (Block B19). The touch controller 302 notifies the recovery control part 201A of the number of touched positions stored in the memory 302A (Block B20).

The recovery control module 201A determines whether there is program information associated with the notified number of touched positions, in the allocation table 109A (Block B21). If the program information is determined to exist (Yes in Block B21), the recovery control module 201A obtains the program information associated with the notified number of touched positions, from the allocation table 109A (Block B22). The recovery control module 201A starts a program, based on a full path of the obtained program information (Block B23).

In Block B21, if no program information is determined to exist (No in Block B21), the recovery control module 201A requests the EC113 to transit to the power-saving mode (Block B24). The EC 113 performs a processing for transit to the power-saving mode (Block B25).

In Block B18, if the recovery is not determined to have been caused by a multi-touch (No in Block B18), the recovery control module 201A displays a pass-code input screen on the LCD 17A (Block B26). When a pass code is input, the recovery control module 201A determines whether the input pass code and a pass code of the recovery control module 201A registered in advance are identical to each other or not (Block B27). If the pass codes are determined to be identical to each other (Yes in Block B27), the EC 113 is requested to transit to the power-saving mode (Block B24). Otherwise, if the pass codes are not determined to be identical (No in Block B27), the normal mode previous to the transit to the power-saving mode is reproduced (Block B28).

As described above, when a multi-touch is made, a program associated with the number of touched positions is started. In general, not a few computers are not provided with any security measure (such as pass code lock) just because higher priority is given to operativity. However, by providing the start method as described, application programs not related with security can be easily used. Accordingly, implementation of security lock is expected to accelerate.

Power-On Method

A description will be made of a method for powering on (into an ON mode) from a power supply OFF (shutdown) mode of the computer 10.

Conventional computers are powered on merely by operating the power button 14. However, the tablet-type computer 10 is often put in a bag, and may therefore be easily powered on by an operation error.

In order to prevent the computer from being powered on by an operation error, the computer 10 does not perform a processing for powering on the computer 10 unless the touchscreen display 17 is multi-touched when the power button 14 is operated.

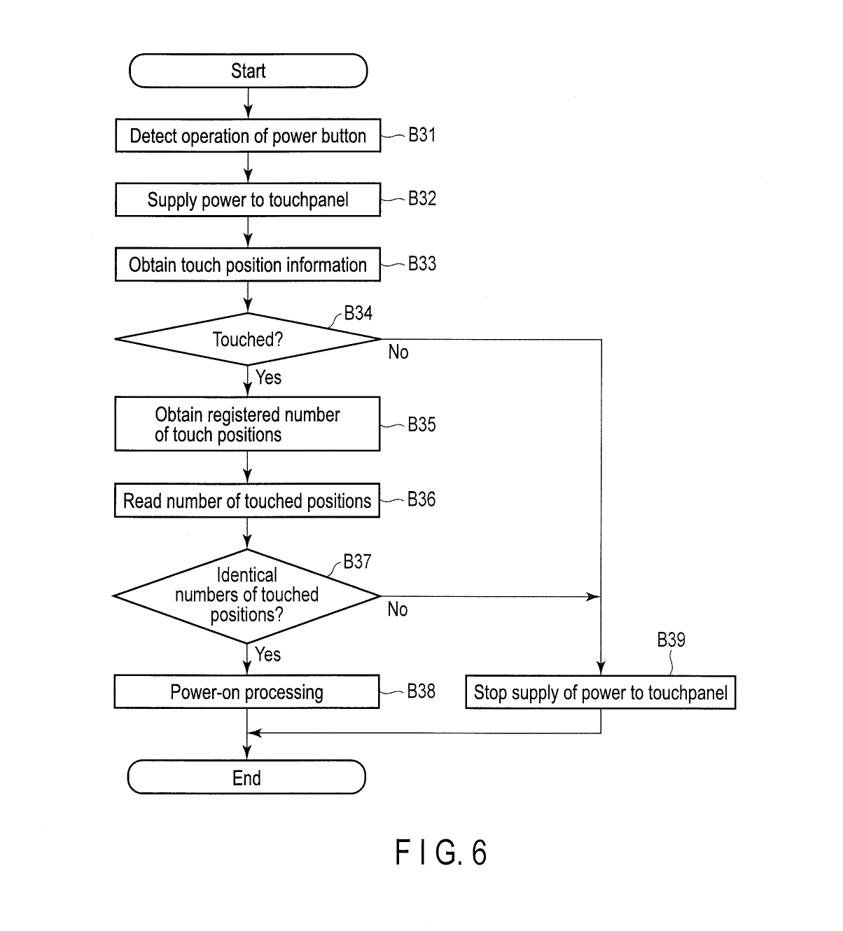

FIG. 6 is a flowchart showing a processing procedure at the time of power-on.

If the EC 113 detects an operation of the power button 14 (Block B31), the EC 113 supplies drive power to the touchpanel 17B (for example, the touch sensor 301 and touch controller 302) (Block B32). The EC 113 obtains touch position information which indicates a touched position from the touch controller 302 (Block B33). If any touch has been detected, the touch controller 302 notifies the EC 113 of touch position information including all coordinates of positions touched. If no touch has been detected, the touch controller 302 notifies the EC 113 of data indicating no touch detected.

According to the notification from the touch controller 302, the EC 113 determines whether a touch has been made or not (Block B34). If a touch is determined to have been made, the EC 113 calculates the number of touched positions, based on the touch position information (Block B35). The EC 113 reads numbers of touched positions, which have been registered in advance, from the memory 113A (Block B36).

The EC 113 determines whether the number of touched positions calculated in Block B34 is identical to a number of touched positions read from the memory 113A (Block B37) or not. If both are determined to be identical to each other (Yes in Block B37), the EC 113 supplies drive power to each of components forming the computer 10, and performs a processing for powering on the computer 10 (Block B38). If both are not determined to be identical to each other (No in Block B37), the EC 113 stops supply of the drive power to the touchpanel 17B (Block B39).

In addition, the memory 113A needs to store numbers of touched positions in advance. If there is no identical number of touched positions stored in the memory 113A, as a comparison result, the two numbers of touched positions in Block B37 may be determined to be identical to each other.

According to the power-on method, a power supply can be prevented from being accidentally turned on, for example, when the apparatus is put in a bag.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising a normal mode and a power saving mode configured to consume less electrical power than in the normal mode, the apparatus comprising:
an electrical power manager configured to perform power management for the apparatus corresponding to each of the normal mode and the power saving mode;
a touchscreen display;
a processor configured to execute one of a first program and at least one other program;
a request module configured to request the electrical power manager to perform the power management corresponding to the normal mode when the touchscreen display detects simultaneous touches at positions while the apparatus is in the power saving mode; and
a controller configured to start the first program and to cause the processor to execute the first program when a number of detected touched positions corresponds to the first program after the apparatus recovers to the normal mode.

2. The apparatus of claim 1, wherein
the controller is configured to prohibit start of the at least one other program, and to prohibit the processor from being switched from the first program to the at least one other program after starting the first program.

3. The apparatus of claim 1, further comprising:
a first storage configured to store first-touch-position count information indicative of the number of detected touched positions when the touchscreen display detects the simultaneous touches; and
a second storage configured to store program information associated with the first-touch-position count information and indicative of the first program,
wherein the controller is configured to acquire the program information from start program information and to start the first program based on the program information.

4. The apparatus of claim 1, further comprising
a power button configured to turn the apparatus from an off mode into an on mode, wherein
the electrical power manager configured to perform a processing to set the apparatus into the on mode when the apparatus is in the off mode and the touchscreen display detects touches at positions during operation of the power button.

5. The apparatus of claim 1, further comprising
a display processor configured to perform a processing for displaying only an image based on display data generated by one of the first program and the at least one other program, on the touchscreen display.

6. A starting method for an electronic apparatus comprising a normal mode and a power saving mode configured to consume less electrical power than in the normal mode, the method comprising:
transiting to the normal mode from the power saving mode when a touchscreen display detects simultaneous touches at positions while the apparatus is in the power saving mode; and
starting a first program when a number of the touched positions corresponds to the first program, after the transition to the normal mode.

7. An electronic apparatus comprising:
a touchscreen display;
a power button configured to cause the apparatus to transit from an off mode to an on mode; and
a starting processor configured to perform a processing for causing the apparatus to transit to the on mode when a power button for turning on the apparatus is operated and the touchscreen display detects simultaneous touches at a preset number of positions, which is two or more.

8. The apparatus of claim 7, further comprising an electronic power manager configured to supply the touchscreen display with drive power when the power button is operated, wherein
the electrical power manager is configured to stop supply of the drive power to the touchscreen display when a number of the touches differs from the preset number.

9. A starting method for an electronic apparatus, the method comprising;
performing a processing for causing the apparatus to transit to an on mode when a power button for turning on the apparatus is operated and the touchscreen display detects simultaneous touches at a preset number of positions, which is two or more.

10. The method of claim 9, further comprising:
supplying the touchscreen display with drive power when the power button is operated; and
shutting off the drive power supplied to the touchscreen display when a number of the positions touched differs from the preset number.
